(19) United States
(12) Patent Application Publication
(10) Pub. No.: US 2007/0242061 A1
(43) Pub. Date: Oct. 18, 2007

(54) Mobile auxiliary display model

(75) Inventors: Matthew P. Rhoten, Kirkland, WA (US); Sriram Viji, Seattle, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/404,601

(22) Filed: Apr. 14, 2006

(51) Int. Cl. G09G 5/00

(52) U.S. Cl. 345/204

(57) ABSTRACT

Embodiments of the invention are directed to a software platform capable of sending data to auxiliary-display devices that are either connected (e.g., wirelessly) to a computing device or associated with the computing device in some way. Embodiments of the invention relate to a mobile auxiliary-display device model that enables communication between a computing device and an auxiliary-display device. Embodiments of the invention are directed to a driver model capable of communicating with wireless devices, such as cell phones, personal digital assistants and the like, via a wireless communication channel, such as Bluetooth® wireless technology. Embodiments of the invention are directed to software that executes on the computing device and software that executes on a mobile auxiliary-display device.

### BACKGROUND

An auxiliary display associated with a computer provides a way for extending, onto a variety of devices with small displays and limited interaction, applications running on a computer. Auxiliary-display devices may include a display embedded in the lid of a laptop computer and various network-connected devices. Unlike technologies that enable the entire operating-system-user experience to be extended to another device, an auxiliary display allows for a subset of functionality onto devices with a constrained screen size, processing power, and interaction capabilities.

### BRIEF SUMMARY

This Brief Summary is provided to introduce a selection of concepts in a simplified form that are further described below in the Detailed Description. This Brief Summary is not intended to identify key features or essential features of the claimed subject matter, nor is it intended to be used as an aid in determining the scope of the claimed subject matter.

Embodiments of the invention are directed to a software platform capable of sending data to auxiliary-display devices that are either connected (e.g., wirelessly) to a computing device or associated with the computing device in some way. Embodiments of the invention relate to a mobile auxiliary-display device model that enables communication between a computing device and an auxiliary-display device. Embodiments of the invention are directed to a driver model capable of communicating with wireless devices, such as cell phones, personal digital assistants and the like, via a wireless communication channel, such as Bluetooth® wireless technology. Embodiments of the invention are directed to software that executes on the computing device and software that executes on a mobile auxiliary-display device.

### BRIEF DESCRIPTION OF THE DRAWINGS

The foregoing Brief Summary, as well as the following Detailed Description, is better understood when read in conjunction with the accompanying drawings, which are included by way of example, and not by way of limitation, with regard to the claimed invention.

FIG. 1 shows an exemplary operating environment within which embodiments of the invention may be implemented.

FIG. 2 is a schematic diagram of a mobile auxiliary-display system in accordance with embodiments of the invention.

FIG. 3 shows components of a computing device in accordance with embodiments of the invention.

FIG. 4 shows components of an auxiliary-display device in accordance with embodiments of the invention.

FIG. 5 depicts computing-device components of a mobile auxiliary-display system in accordance with embodiments of the invention.

FIGS. 6-9 are tables that show the kinds of calls that can be made to an auxiliary-display device (and events that can be received from the device) in accordance with embodiments of the invention.

FIG. 10 is a flow chart showing steps for communicating from a computing device to an auxiliary-display device in accordance with embodiments of the invention.

### DETAILED DESCRIPTION

I. Introduction

Embodiments of the invention are directed to a software platform capable of sending data to auxiliary-display devices that are either connected (e.g., wirelessly) to a computing device or associated with the computing device in some way. Embodiments of the invention relate to a mobile auxiliary-display device model that enables communication between a computing device and an auxiliary-display device. Embodiments of the invention are directed to a driver model capable of communicating with wireless devices, such as cell phones, personal digital assistants and the like, via a wireless communication channel, such as Bluetooth® wireless technology. Embodiments of the invention are directed to software that executes on the computing device and software that executes on a mobile auxiliary-display device.

II. Operating Environment for Embodiments of the Invention

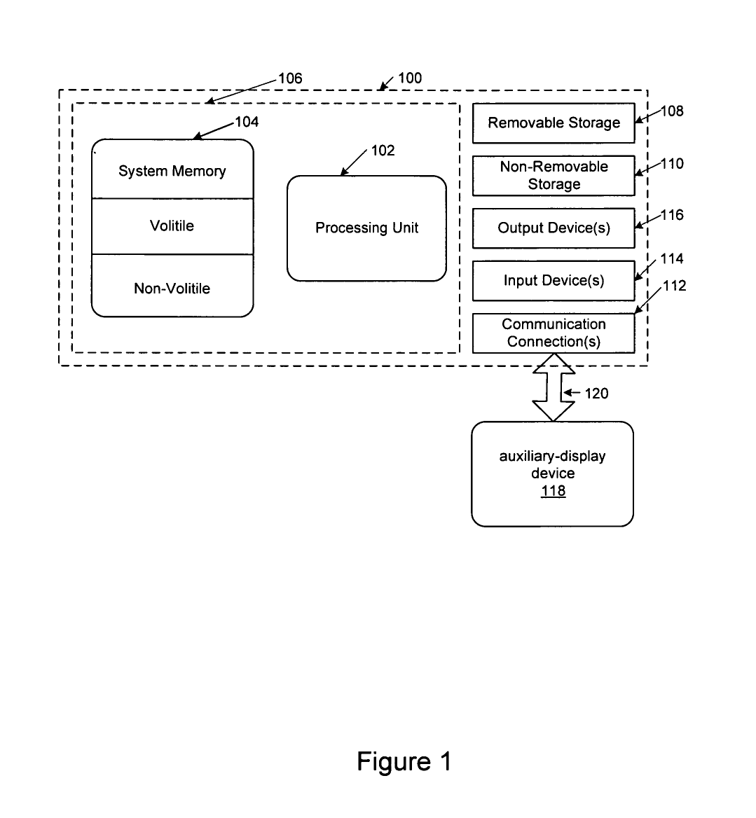

With reference to FIG. 1, an exemplary system for implementing embodiments of the invention includes a computing device, such as computing device 100 and an auxiliary-display device 118. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. Output device(s) 116 such as a display, speakers, printer, etc. may also be included. All these devices are well know in the art and need not be discussed at length here.

The auxiliary-display device 118 may be a cellular telephone, a personal digital assistant, a handheld computer, and the like that communicates with computing device 100 via communication channel 120. In accordance with embodiments of the invention, auxiliary-display device 118 is a Smartphone running Windows CE and the .NET compact framework. As will be apparent, other types of mobile computing devices may be configured with other operating systems in accordance with embodiments of the invention.

III. Mobile Auxiliary-Display System

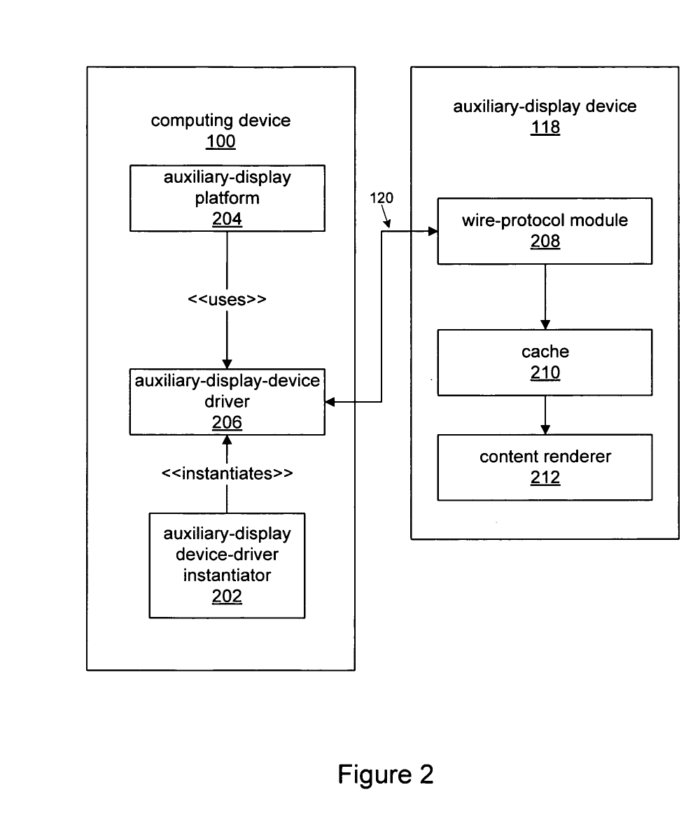

FIG. 2 is a schematic diagram of a mobile auxiliary-display system in accordance with embodiments of the invention. Computing device 100 includes an auxiliary-display device-driver instantiator 202, an auxiliary-display platform 204, and an auxiliary-display device driver 206, which may be instantiated by the auxiliary-display device-driver instantiator 202 as described below.

The mobile auxiliary-display system of FIG. 2 also includes a mobile auxiliary-display device 118, which includes a wire-protocol module 208, a cache 210, and a content renderer 212.

IV. Auxiliary Display Platform

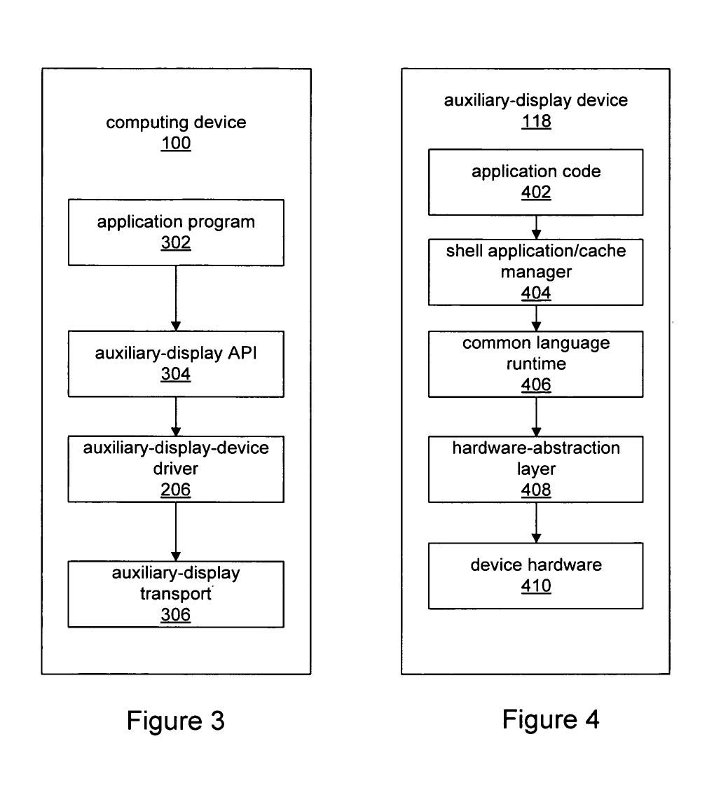

FIG. 2 is similar to FIG. 1 and shows various components of a mobile auxiliary-display system in accordance with embodiments of the invention. The auxiliary-display platform 204 may include an extensible driver model, such that, if a device driver announces itself as an auxiliary-display-device driver, then the auxiliary-display platform 204 will communicate with the auxiliary-display-device driver 206 and start using it. For example, if a user plugs in a USB device that has an auxiliary-display-device driver 206, which the hardware manufacturer has written, when that driver 206 is loaded for that device and the driver 206 registers itself as being associated with an auxiliary-display device 118, then the auxiliary-display platform 204 will notice that the auxiliary-display device 118 has been connected to the computing device 100. Then data can start flowing from an application program 302 (FIG. 3) running on the computing device 100 to the auxiliary-display device 118. Device-driver models typically work in this way where the device driver has a class, which indicates what type of device the driver is for, such as a camera, or a printer, or an auxiliary-display device.

The auxiliary-display driver model, in accordance with embodiments of the invention, defines a way for a hardware manufacturer to write a device driver for their own auxiliary-display device. This driver plugs into two places in the auxiliary-display-driver model. First, the auxiliary-display-device driver 206 receives calls from the auxiliary-display platform 204. Those calls are typically of the form in which the platform 204 requests that the device driver 206 send a specific piece of content to the device 118 or a query regarding the capabilities of the auxiliary-display device 118 or a request to remove content from the device 118, and the like.

FIG. 3 shows components of a computing device 100 in accordance with embodiments of the invention. As shown in FIG. 3, computing device 100 includes application program 302, auxiliary-display API 304, auxiliary-display-device driver 206 and auxiliary-display-transport driver 306.

Application program 302 could be any suitable application program, including, but not limited to, Windows Media Player, Windows Mail, Media Center remote control, RSS, Calendar/Contacts/E-Mail, PowerPoint remote control, and the like. RSS is an acronym for RDF Site Summary or Rich Site Summary, an XML format for syndicating Web content. A Web site that wants to allow other sites to publish some of its content creates an RSS document and registers the document with an RSS publisher. A user that can read RSS-distributed content can use the content on a different site. Syndicated content may include data such as news feeds, events listings, news stories, headlines, project updates, excerpts from discussion forums, and corporate information.

In accordance with embodiments of the invention, an auxiliary-device driver 206, which may be written by an independent hardware vendor (IHV), an independent software vendor (ISV), or the like, may plug into the actual transport, which is depicted as auxiliary-display-transport driver 306, that's going to communicate with the device. So, it could call into universal serial bus (USB), for example to talk to a USB-connected auxiliary-display device. Various implementations may use APIs that are not directly exposed by device drivers, including, but not limited to, TCP/IP. Embodiments of the invention may use something that isn't itself a driver (e.g., a library that eventually used Windows® APIs to communicate with a driver) to communicate with an auxiliary-display device.

In accordance with embodiments of the invention, auxiliary-display-transport driver 306 may be, among other suitable transports, a user-mode Bluetooth® API. So, when a call comes in from the auxiliary-display platform requesting that data be added to the auxiliary-display device 118, the auxiliary-display-device driver 206 calls the transport APIs (e.g., Bluetooth® APIs) 306 to send the data to the auxiliary-display device 118. Bluetooth® APIs, for example, are like networking APIS in that they provide a pipe over which bytes can be written. So, embodied in the auxiliary-display driver 206 is the wire protocol for sending different pieces of information to the device 118. So, the driver 206 implements a protocol on top of just a plain byte stream, which is what the transport 306 provides.

An auxiliary-display platform 204, in accordance with embodiments of the invention, may advantageously be transport independent so that a new device driver can be plugged in and a new transport may be used to talk to the device. “Transport” as used herein refers to the transport layer, which is the middle layer in the OSI seven-layer model. The transport layer determines how to use the network layer to provide a virtual error-free, point to point connection so that host A can send messages to host B and they will arrive un-corrupted and in the correct order. It establishes and dissolves connections between hosts. It is used by the session layer. An example transport layer protocol is Transmission Control Protocol (TCP).

In accordance with an embodiment of the invention, TCP/IP may be used to connect to a server, which in turn connects to the auxiliary-display device over a cell network. Some auxiliary-display devices (e.g., cell phones) have WIFI antennas. The computing device may connect to an auxiliary-display device 118 via WIFI instead of Bluetooth. WIMAX and UWB and other later-developed radio technologies could also be used in an auxiliary-display device 118, such as a cell phone or PDA, in accordance with embodiments of the invention. So, in principle, transports, such as USB or a radio, which find their way into a device and that can also be used from a computing device, may be used by an auxiliary-display platform 204 in accordance with embodiments of the invention. When ultra-wideband (UWB) and WIMAX (i.e., the name commonly given to the IEEE 802.16 standard) go into cell phones, for instance, these would be suitable transports for use with embodiments of the invention.

If the mobile auxiliary-display device is a cell phone, then it could communicate directly to a cell network and get data from the cell network. With USB, an auxiliary-display device would be wire-connected to the computing device. With Bluetooth, the auxiliary-display device would probably have a range of about 30 meters or so (depending on the Bluetooth® radio). An auxiliary-display device may communicate with a computing device 100 through a wireless implementation via 802.11 or via over-the-air cellular networks, which would mean that the cell phone could then get data whenever the cell phone is connected to the cellular network.

An embodiment of the invention that is Bluetooth-specific is discussed in detail herein. Nevertheless, other transports, including but not limited to, the transports mentioned above and later developed transports, may also be used in accordance with embodiments of the invention.

V. Bluetooth-Enabled Auxiliary-Display System

As mentioned above, in accordance with embodiments of the invention, an auxiliary-display-device driver 206 communicates with the auxiliary-display device 118 via Bluetooth. When the driver 206 is instantiated, the driver 206 should know what Bluetooth® device the driver 206 should communicate with. Bluetooth® devices have unique identifiers (IDs), like network cards have unique IDs.

A Bluetooth® framework, in accordance with embodiments of the invention, indicates when a Bluetooth-enabled device, such as a Bluetooth-enabled auxiliary-display device 118) comes in range and when the device goes back out of range. Code detects these events. So, if a user brings an auxiliary-display device 118 into radio range of the user's computing device 100, this code would get notified that the auxiliary-display device 118 is in range such that data may be exchanged with the auxiliary-display device 118. Also, the auxiliary-display-device driver 206 may be instantiated and told, as part of the instantiation, what device to communicate with. That's how the ephemeral nature of a mobile auxiliary-display device 118, which may go out of range with no notice, may be handled. The auxiliary-display-device driver 206 exchanges data with the auxiliary-display device 118, and then when the auxiliary-display-device driver 206 notices that the radio operations start to fail, the auxiliary-display device-driver instantiator 202 may unload the auxiliary-display-device driver 206. The next time the auxiliary-display device comes within range, the auxiliary-display device-driver instantiator 202 will again instantiate the auxiliary-display-device driver 206.

In accordance with embodiments of the invention, an auxiliary-display-device driver uses Bluetooth® APIs to talk to a Bluetooth-enabled auxiliary-display device. Bluetooth® devices can expose services. So, for example, a cell phone typically exposes multiple Bluetooth® services, including, but not limited to, personal area networking, headphone profile, virtual serial port, and the like. Bluetooth® calls these services profiles, and there are many profiles that devices can expose. Some devices expose a single profile, for example, a Bluetooth® headset for use with a phone may expose only the headset profile. Suppose the headset is discoverable, so that a user can pair it with the user's cell phone. So, the cell phone performs device discovery and finds the headset. Then the cell phone performs service discovery thereby asking the headset to tell the cell phone what services the headset exposes, and the headset tells the cell phone.

In code, new services may be exposed via Bluetooth®. So, the code on the auxiliary-display device may expose a new service, with a unique auxiliary-display device-service ID, from the auxiliary device. The auxiliary-display device driver, when it connects to a Bluetooth® device, connects to that service ID. It can be thought of like a TCP/IP service port, which has a unique ID, which happens to be a number. For Bluetooth®, the unique IDs are not numbers; they're GUIDs, which are globally unique identifiers. But it's basically the same idea. Services have their own respective unique IDs through which they can be connected to. So, we have a unique ID chosen for the auxiliary-display protocol over Bluetooth. Advantageously, when a Bluetooth® device comes in range, the code that is going to instantiate the device driver may use the presence or absence of this service to help decide whether to instantiate the device driver. So, it sees the device come in range, and it performs service discovery on that device (i.e., it asks the device what services the device exposes), the device responds and indicates what services the device exposes (e.g., headset profile, personal area networking, auxiliary-display profile, etc.). If the device exposes the auxiliary-display profile, then the code would instantiate an auxiliary-display-device driver for the device. But if the device did not expose the auxiliary-display profile, then the code would not instantiate an auxiliary-display device driver to connect with the device. In this way, auxiliary-display device drivers are created for Bluetooth® devices that support an auxiliary display and are not created for devices that do not support an auxiliary display.

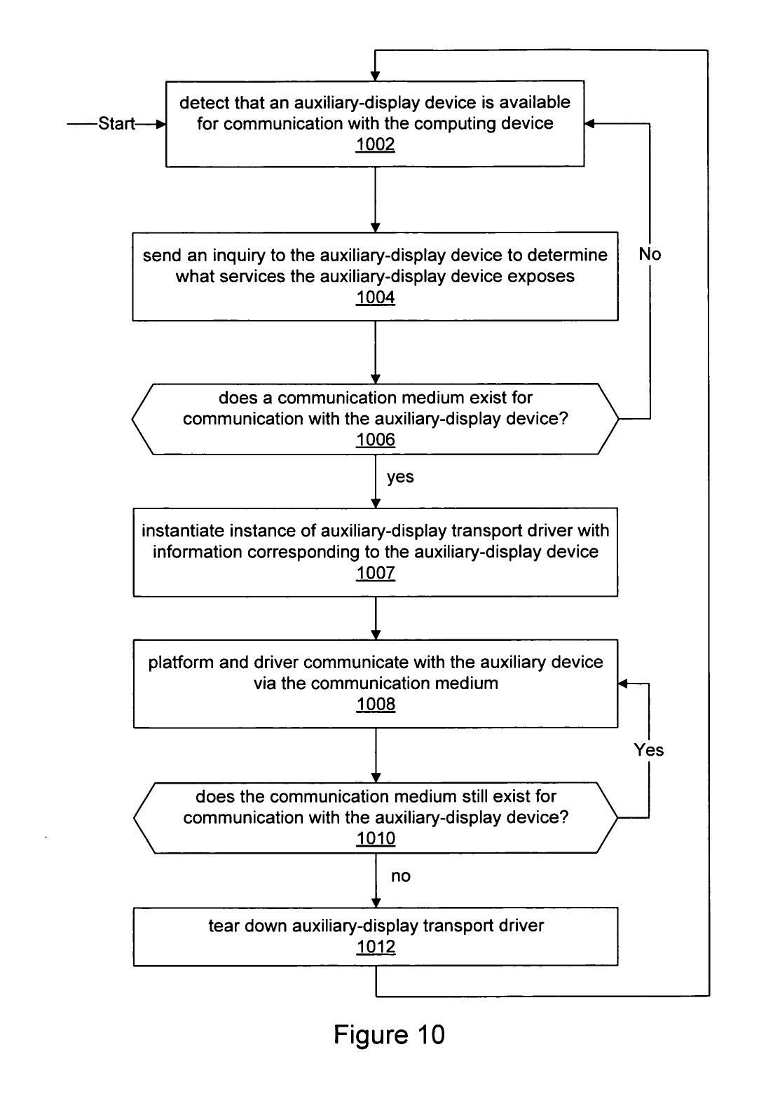

FIG. 10 is a flow chart showing steps for communicating from a computing device to an auxiliary-display device in accordance with embodiments of the invention. As shown at 1002, whether an auxiliary-display device is available for communication with the computing device is detected. An inquiry is sent to the auxiliary-display device to determine what services the auxiliary-display device exposes, as shown at 1004. Based on the services exposed by the auxiliary-display device, a determination is made regarding whether a communication medium exists for communication with the auxiliary-display device, as shown at 1006. If no such medium exists, processing returns to step 1002. Upon determining that a communication medium exists for communication with the auxiliary-display device, an instance of the auxiliary-display transport driver is instantiated with information corresponding to the auxiliary-display device, as shown at 1007, and communication is established with the auxiliary device via the communication medium, as shown at 1008. A determination is then made with respect to whether the communication medium still exists, as shown at 1010. If the medium still exists, processing loops to step 1008. Otherwise, if the communication medium no longer exists, then the auxiliary-display transport driver is unloaded (i.e., torn down), as shown at 1012.

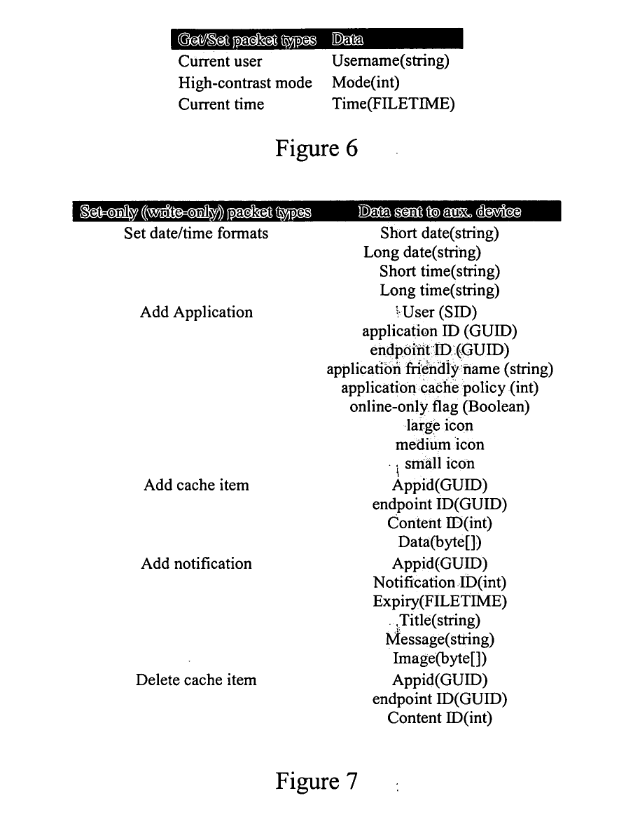

FIG. 5 depicts computing-device components of a mobile auxiliary-display system in accordance with embodiments of the invention. As shown in FIG. 5, client application 502 communicates with auxiliary display client API layer 504, which interacts with WPD API layer 506. WPD API layer 506 in turn communicates with Windows user-mode driver framework 508. Windows user-mode driver framework 508 includes WPD serializer/deserializer 510 and enhanced auxiliary-display driver 512, and auxiliary display class extension 514. Windows user-mode driver framework 508 uses Bluetooth® API 516.

To identify and connect to auxiliary display devices, the mobile auxiliary-display system of FIG. 5 may use Function Discovery (FD), the Windows Portable Device (WPD) framework, and the User Mode Device Framework (UMDF), which are components of Microsoft Windows Vista™ operating system.

Application programs may communicate with the auxiliary-display APIs, and do not need to worry about the layers below them. This advantageously abstracts ISV applications from having to understand specific properties of each auxiliary-display device 118. Device capabilities may be exposed upon request.

VI. Auxiliary Display Device

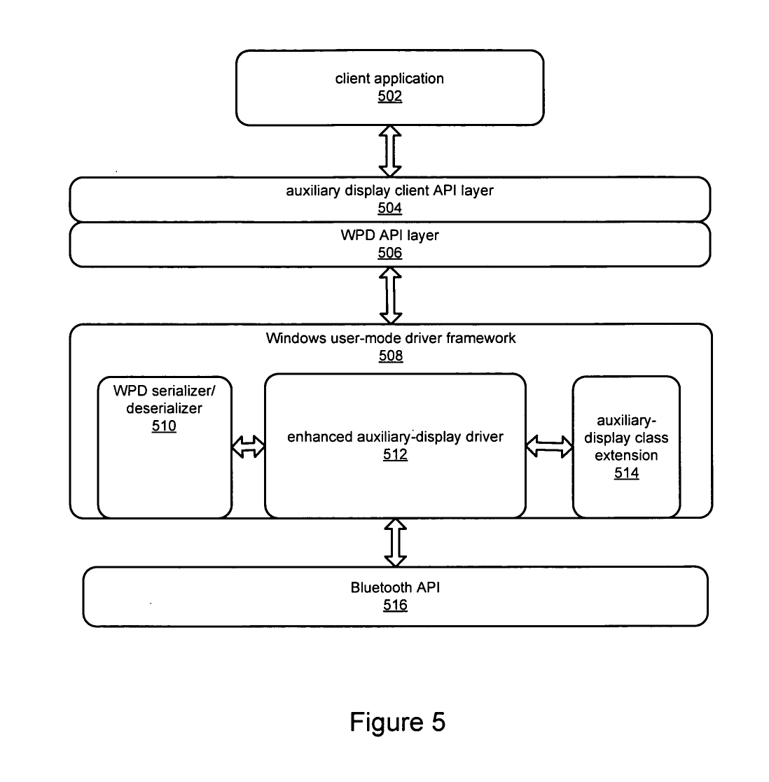

FIG. 4 shows components of an auxiliary-display device 118 in accordance with embodiments of the invention. As shown in FIG. 4, auxiliary-display device 118 includes application code 402, shell application/cache manager 404, common language runtime 406, hardware-abstraction layer 408, and device hardware 410.

In accordance with embodiments of the invention, code runs on the auxiliary-display device 118. This code may include: a content renderer 212 that renders content to the user and a wire-protocol module 208 corresponding to the wire protocol in the auxiliary-display-device driver 206. When the device driver sends content to the device 118, it wraps it up with a header that says, “this data is adding content to the device.” Then the data and the header may be sent via the transport driver 206 (e.g., via radio waves) to the device 118. The code on the device 118 then processes that data stream. The code may then look at the data to determine whether a packet is adding content to the device 118 and may then process it appropriately. So, both the device driver 206 and the code running on the device 118 may implement a wire protocol in accordance with embodiments of the invention. An example wire protocol in accordance with embodiments of the invention is discussed below.

Other portions of the code on the auxiliary-display device 118 deal with operations that are performed once data has been received from the computing device 100. For instance, storing the data, examining the data and determining where data should be stored, and displaying the data for the user.

On the auxiliary-display device 118, the wire-protocol module 208 exchanges data with the computing device 100. The wire-protocol module 208 receives data from the computing device 100 and tells the computing device 100 what the auxiliary-display device's capabilities are and the like. When the auxiliary-display device 118 receives data from the computing device 100, the auxiliary-display device 118 may cache the data for later use.

The auxiliary-display device may include a content renderer 212 that renders specific kinds of data that comes from the auxiliary-display platform 204. The auxiliary-display platform may include a common data type used by applications on the computing device. The content renderer 212 reads the cached data and may then construct user interface and interaction based on that data.

There's a shell 404 wrapped around on top of other code modules. The shell 404 may list the applications that are communicating with the auxiliary-display device 118 and may let a user navigate among those applications. There may be an XML parser, which, according to one implementation, sits on top of Windows Mobile® and the .NET Compact Framework.

As will be apparent, a driver and code to run on a phone could be written on other phone platforms, including, but not limited to, J2ME or Symbian code, or UIQ in accordance with embodiments of the invention.

VII. “Today Screen”

An embodiment of the invention that is specific to Windows Mobile® devices, such as Pocket PCs and Smartphones, which have a feature called a “Today Screen,” which will show the user her upcoming appointments in the device's calendar or e-mails that are new, and the like. The Today Screen is extensible. Code can be written that will cause a UI element to show up in that screen with new information. In accordance with the embodiment, glanceable information (i.e., timely information for the user, such as when and where the user's next meeting is) may be communicated to, and displayed via, a Windows Mobile® auxiliary-display device 118.

VIII. Wire Protocol

A wire protocol in accordance with embodiments of the invention may be relatively straight forward. For instance, if a computing device 100 is going to send content to an auxiliary-display device 118, the protocol is as follows. The computing device 100 sends a packet to the auxiliary-display device, and the packet has two types of information: (1) the header, which includes things like: an indication of what kind of packet it is, such as a packet that adds content to the auxiliary device 118 and/or specifies what the ID of the content being added is, and the like; and (2) the packet's data portion. In response, the auxiliary device 118 sends an acknowledgement packet, which indicates whether the packet was received successfully, and optionally may return other information to the computing device 100.

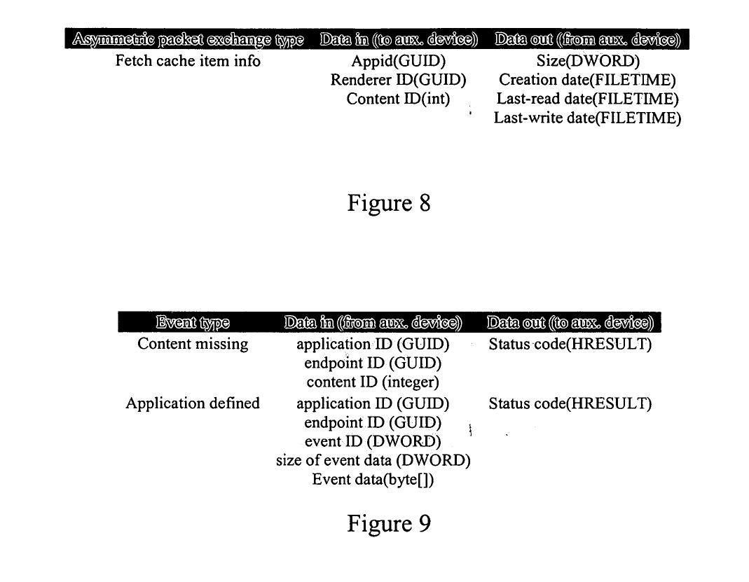

FIGS. 6-9 are tables that show the kinds of calls that can be made to an auxiliary-display device (and events and events that can be received from the device) in accordance with embodiments of the invention. Unless noted, get-set and write-only packets receive a acknowledgement reply packet containing an error-result code.

FIG. 6 contains the get/set packets. Each line in the table corresponds to two packet types, one to set the value on the device 118 and one to get it from the device.

FIG. 7 shows the packets where data is sent to the auxiliary display 118 and a status code is expected in acknowledgement.

FIG. 8 shows the packet exchanges that are asymmetric; the sent request and the reply both contain data, of different kinds, and the reply is something more than just an ack/status-code.

FIG. 9 shows events that come from the device 118. The “Data in” column for this type of packet represents a packet from the auxiliary display to the computing device.

IX. Concluding Remarks

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We Claim:

1. A computing device for use in an auxiliary-display system, the computing device comprising:
an auxiliary-display platform;
an auxiliary-display-device driver; and
an auxiliary-display device-driver instantiator that instantiates the auxiliary-display-device driver upon determining that an auxiliary-display device is available for communication with the computing device via the auxiliary-display-device driver.

2. The computing device of claim 1, wherein the auxiliary-display device-driver instantiator identifies the auxiliary-display device to the auxiliary-display-device driver.

3. The computing device of claim 1, wherein the computing device communicates with the auxiliary-display device via the auxiliary-display-device driver.

4. The computing device of claim 1, wherein, upon determining that the auxiliary-display device is unavailable for communication with the computing device via the auxiliary-display-device driver, the auxiliary-display-device-driver instantiator causes the auxiliary-display driver to unload.

5. The computing device of claim 1, wherein the computing device further comprises: an application program that communicates with the auxiliary-display device via the auxiliary-display platform.

6. The computing device of claim 1, wherein the computing device further comprises: an auxiliary-display-transport driver.

7. The computing device of claim 6, wherein the auxiliary-display-device driver uses the auxiliary-display-transport driver to communicate with the auxiliary-display device.

8. The computing device of claim 7, wherein the auxiliary-display-device driver uses the auxiliary-display-transport driver to wirelessly communicate with the auxiliary-display device.

9. The computing device of claim 8, wherein the auxiliary-display-transport driver communicates with the auxiliary-display device via a Bluetooth® radio connection.

10. The computing device of claim 8, wherein the auxiliary-display-transport driver communicates with the auxiliary-display device via a cellular telephone network.

11. An auxiliary-display device for use in an auxiliary-display system, the auxiliary-display device comprising:
a cache;
a content renderer; and
a wire-protocol module that exposes, to a computing device, a service, with an auxiliary-display device-service identifier and that accepts a communication connection from the computing device via the auxiliary-display device-service identifier.

12. The auxiliary-display device of claim 11, wherein the auxiliary-display device is cellular telephone.

13. The auxiliary-display device of claim 11, wherein the auxiliary-display device is a personal digital assistant.

14. The auxiliary-display device of claim 13, wherein the communication connection is wireless.

15. The auxiliary-display device of claim 14, wherein the wireless communication connection is a Bluetooth® radio connection.

16. The auxiliary-display device of claim 14, wherein the wireless communication connection is via a cellular telephone network.

17. A computer-readable medium that contains computer-executable instructions for communicating from a computing device to an auxiliary-display device by performing steps comprising:
detecting that an auxiliary-display device is available for communication with the computing device;
sending an inquiry to the auxiliary-display device to determine what services the auxiliary-display device exposes;
based on the services exposed by the auxiliary-display device, determining whether a communication medium exists for communication with the auxiliary-display device; and
upon determining that a communication medium exists for communication with the auxiliary-display device, communicating with the auxiliary device via the communication medium.

18. The computer-readable medium of claim 17, wherein the auxiliary-display device is a cellular telephone.

19. The computer-readable medium of claim 17, wherein the communication medium is a Bluetooth® radio connection.

20. The computer-readable medium of claim 17, wherein the communication medium is a cellular telephone network.
